(19) United States
(12) Patent Application Publication
(10) Pub. No.: US 2010/0110297 A1
(43) Pub. Date: May 6, 2010

(54) Video displaying apparatus and setting information displaying method

(75) Inventor: Shinpei Kameoka, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/589,496

(22) Filed: Oct. 23, 2009

(30) Foreign Application Priority Data
Nov. 6, 2008 (JP) P2008-285231

(51) Int. Cl. H04N 5/50; H04N 5/66

(52) U.S. Cl. 348/569; 348/739; 348/E05.097; 348/E05.133

(57) ABSTRACT

There is provided a video displaying apparatus includes a plurality of video input units for inputting mutually different video signals; a display unit for displaying the video signals thereon; and a display control unit for displaying setting information on a display setting of a video signal input from the individual video input unit on the display unit in a list.

### BACKGROUND OF THE INVENTION

1. Field of the Invention

The present invention relates to a video displaying apparatus and a setting information displaying method.

2. Description of the Related Art

In recent years, there are widely used a thin television receiver with large screen, a display apparatus and the like (referred to as video displaying apparatus below). One reason therefor includes the fact that the cost of display panel, calculation processing chip or the like used for the video displaying apparatus is lowered, which leads to a reduction in the cost of the video displaying apparatus itself, so that a user can easily buy a thin video displaying apparatus with large screen. Further, the thin video displaying apparatus can be installed in a smaller area as compared with a CRT (Cathode Ray Tube) displaying apparatus in related art. Thus, even a video displaying apparatus with large screen can be advantageously installed without problem. It is assumed that the video displaying apparatus with large screen has been widely used from the above reason. Further, along with digitalization and high functionalization in recent years, it is possible to treat not only broadcast waves or optical disk reproducing apparatuses but also many sources such as contents inside flash memory or over network unlike previously.

First of all, along with the wide use of a video displaying apparatuses with large screen, attention is paid to a technique for displaying many videos in a large display region and mutually comparing and referring to the videos. For example, Japanese Patent Application Laid-Open No. 2002-120350 described below describes therein an example for dividing a display screen for use. The technique in Japanese Patent Application Laid-Open No. 2002-120350 relates to a technique for adjusting image quality in each of the divided display screens. Japanese Patent Application Laid-Open No. 2006-311296 described blow describes therein a technique for dividing an input image into a plurality of partial images to form a multi-screen and adjusting image quality of the individual partial images to arrange the same on one screen.

### SUMMARY OF THE INVENTION

As described above, each Japanese Patent Application Laid-Open No. 2002-120350 and No. 2006-311296 described above describes therein a method for taking advantage of a large screen to efficiently adjust image quality or sound quality. However, there is not disclosed therein a technique for efficiently adjusting image quality of the videos input from a plurality of video sources into a video displaying apparatus. As described previously, the kinds of videos input into the video displaying apparatus are remarkably diversified in recent years. For example, a user can easily receive terrestrial analog broadcasting, terrestrial digital broadcasting, BS broadcasting, CS broadcasting and the like for viewing. Further, when a recording/reproducing apparatus, optical disk reproducing apparatus and the like are connected to the video displaying apparatus, the video displaying apparatus is input with videos also from the external devices.

If an input source of video is different, the video is differently viewed even at the same image quality setting. Thus, the user needs to perform image quality setting for each input source. Further, since many input sources are present as described above, the user needs to perform setting while changing a setting screen for each input source. Consequently, the user gives up the complicated setting for each input source and views a video at an inappropriate image quality adjustment value or views a video at an inconsistent adjustment value for each input source. Further, when the image quality setting is completed for one input source, the user may regard the setting of image quality for all the input sources as being completed by mistake in some cases. Also in such a case, the user can view the video at an inappropriate image quality setting. From the reason, it is required to take advantage of a large screen and to efficiently set image quality adjustment values for several input sources with simple operation.

Therefore, the present invention has been made in views of the above problems and it is desirable to provide a novel and improved video displaying apparatus and setting information displaying method for efficiently recognizing and inputting setting information corresponding to a plurality of different input sources.

According to an embodiment of the present invention, there is provided a video displaying apparatus which includes a plurality of video input unit configured to input mutually different video signals; a display unit configured to display the video signals thereon; and a display control unit for displaying setting information on a display setting of a video signal input from the individual video input unit on the display unit in a list.

Furthermore, the setting information may be provided with a plurality of setting items. The video displaying apparatus may further include an arrangement order table storage unit configured to record therein an arrangement order of the setting items in correspondence to the individual video input unit or a predetermined display mode. The display control unit, when one item of setting information displayed in a list on the display unit is selected or when a predetermined display mode is selected, may rearrange the plurality of setting items based on the arrangement order recorded in the arrangement order table storage unit.

The video displaying apparatus may further include a difference setting detection unit, when the setting information as a reference is determined, configured to detect setting information having a large difference relative to the reference setting information. Furthermore, the display control unit may arrange setting information detected by the difference setting detection unit together with the reference setting information and displays them in a list on the display unit.

Furthermore, the difference setting detection unit, when a user selects one item of setting information displayed in a list on the display unit, may detect the setting information having a large difference with the selected setting information as the reference setting information.

Furthermore, the difference setting detection unit, when a predetermined display mode is selected, may detect the setting information having a large difference with the setting information corresponding to the display mode as the reference setting information.

The video displaying apparatus may further include a setting information replication unit configured to overwrite one item of setting information selected from the items of setting information displayed in a list on the display unit on the other item of setting information. Furthermore, the setting information replication unit, when the one item of setting information as replication source and the other item of setting information as replication destination are selected, may overwrite the information on all the setting items contained in the one item of setting information on the setting items contained in the other item of setting information.

The video displaying apparatus may further include a setting information replication unit configured to overwrite one item of setting information selected from the items of setting information displayed in a list on the display unit on the other item of setting information. Furthermore, the setting information replication unit, when the one item of setting information as replication source and the other item of setting information as replication destination are selected and part of the setting items contained in the one item of setting information is selected, may overwrite the information on the selected setting item among the setting items contained in the one item of setting information on the setting items contained in the other item of setting information.

Furthermore, the display control unit, when setting information corresponding to the two video input units is selected, may display a setting change screen for changing one item of setting information, a changed video screen for displaying thereon a video signal based on setting information changed in the setting change screen, an unchanged video screen for displaying thereon the video signal before setting change, and a comparison video screen for displaying thereon a video signal based on the setting information different from the one item of setting information for comparison in a list on the display unit.

According to another embodiment of the present invention, there is provided a method for displaying setting information, including the steps of inputting videos into a plurality of video input units to which mutually different video signals are input; and displaying setting information on a display setting of a video signal input from the individual video input unit in a list on a display screen.

According to another embodiment of the present invention, there is provided a program to cause a computer to realize functions held by the abovementioned apparatus. Further, a computer readable recording medium in which the program is recorded may be provided.

According to another embodiment of the present invention, there is provided a video displaying apparatus which includes a plurality of video input means for inputting mutually different video signals; display means for displaying the video signals thereon; and display control means for displaying setting information on a display setting of a video signal input from the individual video input means on the display means in a list.

As described above, according to the present invention, it is possible to efficiently recognize and input setting information corresponding to a plurality of different input sources.

### BRIEF DESCRIPTION OF THE DRAWINGS

FIG. 1 is an explanatory diagram showing a difference in input source and a difference in setting information;

FIG. 2 is an explanatory diagram showing a configuration example of a setting screen;

FIG. 3 is an explanatory diagram showing a configuration example of a video displaying system according to one embodiment of the present invention;

FIG. 4 is an explanatory diagram showing a hardware configuration example of a video displaying apparatus according to the embodiment;

FIG. 5 is an explanatory diagram showing a functional configuration of the video displaying apparatus according to the embodiment;

FIG. 6 is an explanatory diagram showing one example of setting information according to the embodiment;

FIG. 7 is an explanatory diagram showing a configuration example of the setting screen according to the embodiment;

FIG. 8 is an explanatory diagram showing one example of a method for replicating setting information according to the embodiment;

FIG. 9 is an explanatory diagram showing one example of the method for replicating setting information according to the embodiment;

FIG. 10 is an explanatory diagram showing one example of the method for replicating setting information according to the embodiment;

FIG. 11 is an explanatory diagram showing one example of the method for replicating setting information according to the embodiment;

FIG. 12 is an explanatory diagram showing one example of the method for replicating setting information according to the embodiment;

FIG. 13 is an explanatory diagram showing one example of the method for replicating setting information according to the embodiment;

FIG. 14 is an explanatory diagram showing one example of the method for replicating setting information according to the embodiment;

FIG. 15 is an explanatory diagram showing one example of the method for replicating setting information according to the embodiment; and

FIG. 16 is an explanatory diagram showing a method for finely adjusting setting information according to the present embodiment.

### DETAILED DESCRIPTION OF EMBODIMENT

Hereinafter, preferred embodiments of the present invention will be described in detail with reference to the appended drawings. Note that, in this specification and the appended drawings, structural elements that have substantially the same function and configuration are denoted with the same reference numerals, and repeated explanation of these structural elements is omitted.

### [Flow of Explanation]

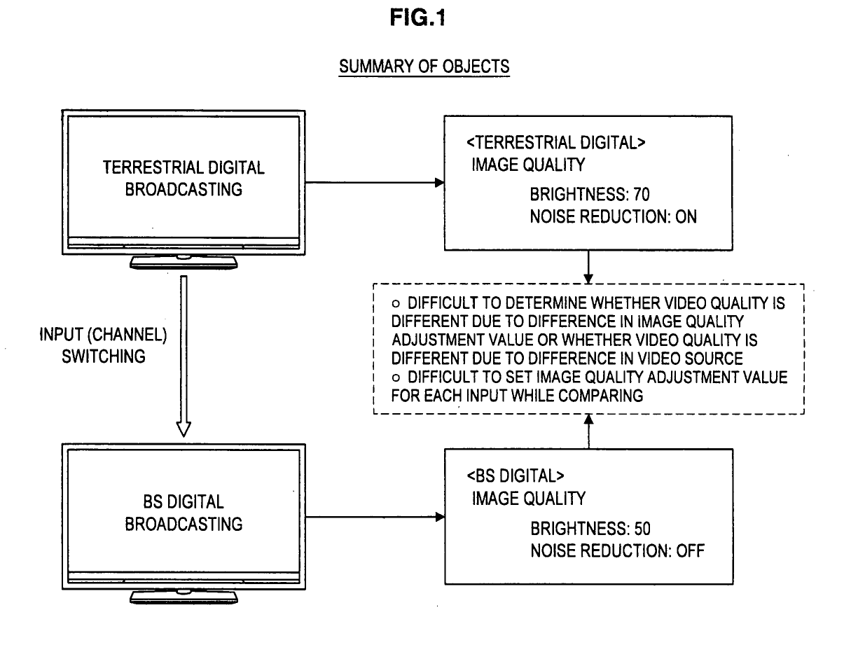

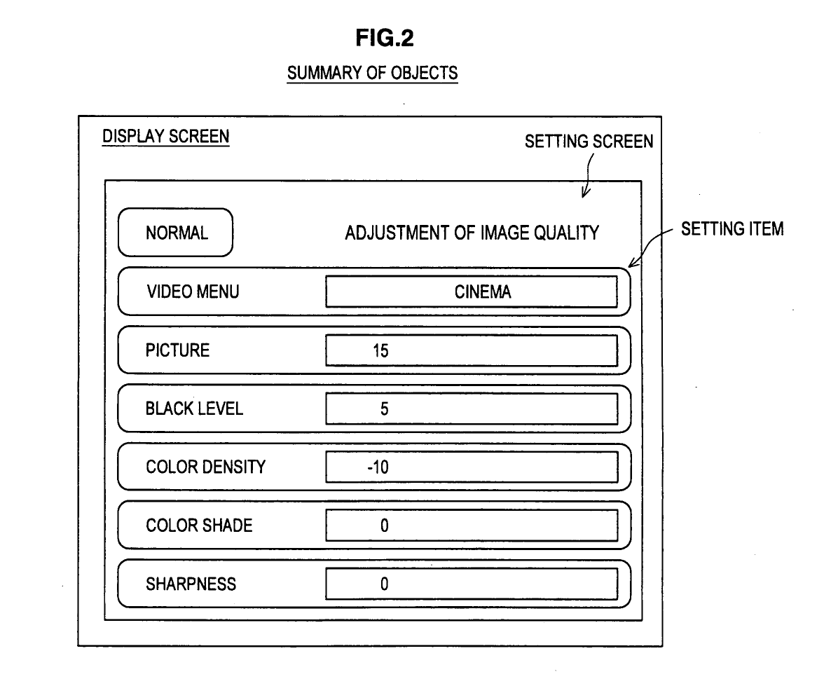

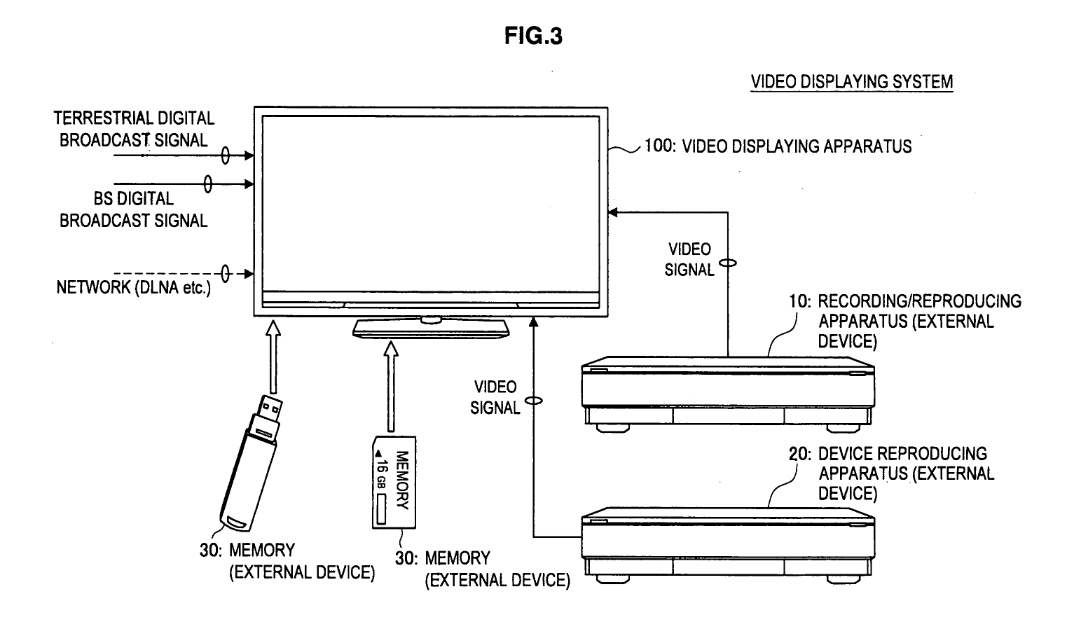

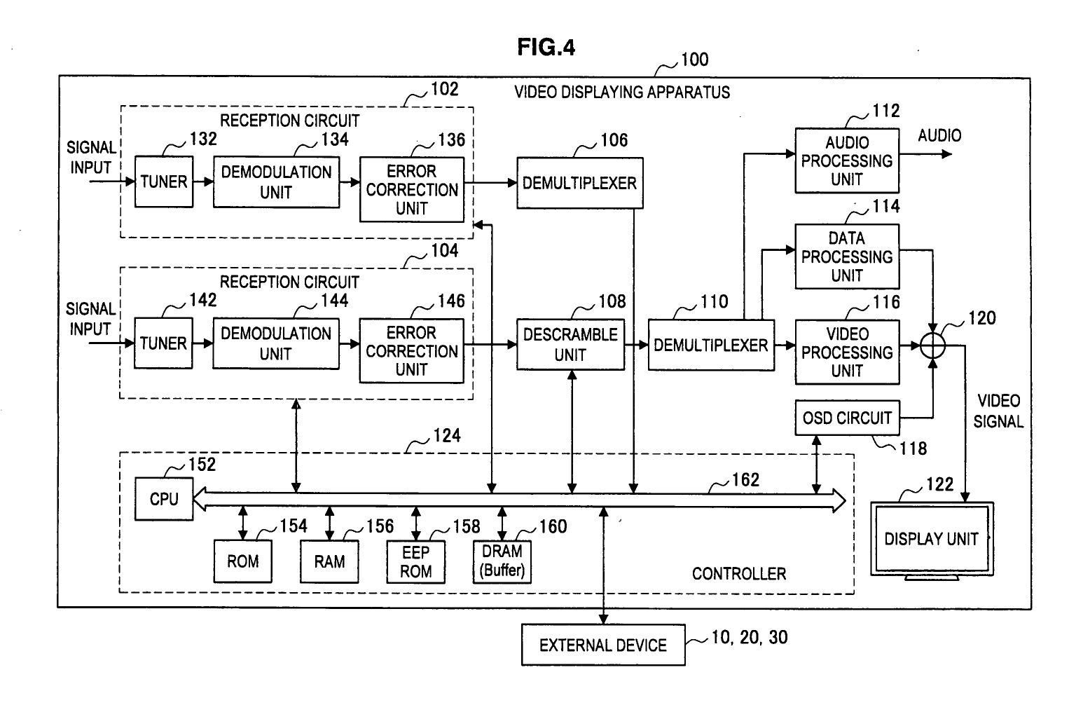

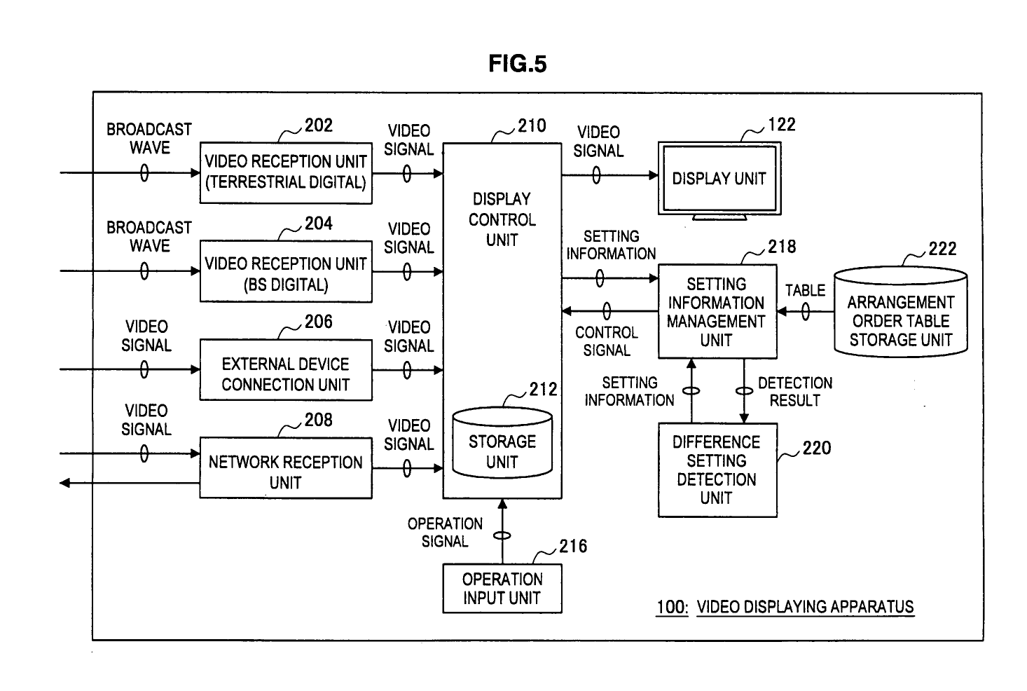

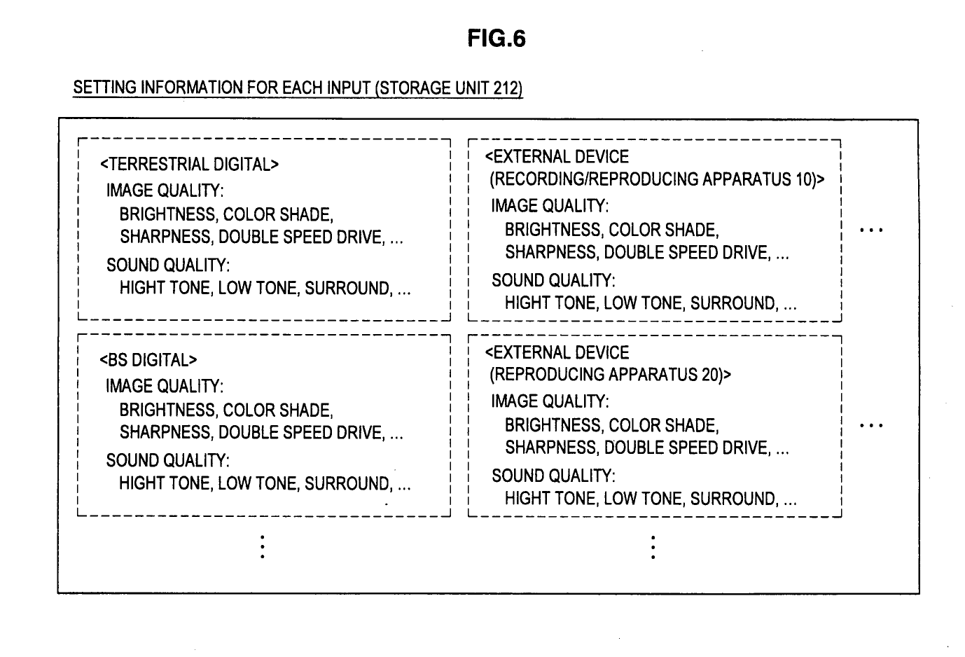

Here, a flow of explanation for an embodiment according to the present invention described later will be briefly described. First, the objects to be solved by the present embodiments will be simplified with reference to FIGS. 1 and 2. Next, a system configuration of a video displaying system according to the present embodiment will be described with reference to FIG. 3. Then, a hardware configuration example of a video displaying apparatus according to the present embodiment will be described with reference to FIG. 4. Then, a functional configuration of the video displaying apparatus according to the present embodiment will be described with reference to FIG. 5. A setting information displaying method by the video displaying apparatus and a video displaying method will be described with reference to FIGS. 6 to 16 as needed. Finally, a technical spirit of the present embodiment will be concluded and operational effects obtained from the technical spirit will be briefly described.

### Explanation Items

1: Summary of objects

2: System configuration of video displaying system

3. Hardware configuration example of video displaying apparatus 100

4: Functional configuration of video displaying apparatus 100

5: Setting information replicating method processing

6: Flow of setting information replication

7: Method for finely adjusting setting information

8: Conclusion

### 1: SUMMARY OF OBJECTS

There will be briefly summed the objects to be solved by the present embodiment before explaining the technique according to one embodiment of the present invention in detail.

FIG. 1 will be first referred to. In recent years, a reception tuner capable of receiving several broadcast waves is incorporated in a digital broadcast apparatus such as television receiver. The digital broadcast apparatus is provided with connection terminals for external devices so as to connect with a recording/reproducing apparatus, optical media reproducing apparatus and the like. Thus, a user can view video signals or audio signals (simply referred to as videos below) input from the video sources (referred to as input sources below). For example, the user can use one digital broadcast apparatus to view the programs of terrestrial digital broadcasting and the programs of BS digital broadcasting.

Typically, the user makes adjustment of image quality, sound quality and the like when or before viewing a video. For example, adjustment is made on color shade, sharpness, contrast, sound effect and the like. However, if many input sources are present as described above, many adjustment values need to be set, which imposes a large load on the user. Further, when an input source (channel) is switched, it is difficult to understand whether a difference in image quality appearing before and after the switching is due to a difference in adjustment value at the digital broadcast apparatus side or a difference in input source. On the other hand, even if all the adjustment values can be collectively set, it is difficult to know whether one adjustment value is appropriate for other input sources, and the image quality of the videos input from some input sources may be degraded.

For example, as shown in FIG. 1, there will be specifically considered a case in which the input source is switched from terrestrial digital broadcasting to BS digital broadcasting. In the example of FIG. 1, it is assumed that a value of “brightness=70, noise reduction=ON” is set as the setting information of the terrestrial digital broadcasting at the digital broadcast apparatus side. Further, it is assumed that a value of “brightness=50, noise reduction=OFF” is set as the setting information of the BS digital broadcasting. In other words, the digital broadcast apparatus exemplified in FIG. 1 is of a type in which an adjustment value is set for an individual input source. For example, it is assumed that the image quality satisfying the user is obtained when the terrestrial digital broadcasting is being displayed. Further, it is assumed that the image quality satisfying the user may not be obtained after the input source is switched to the BS digital broadcasting.

In this case, the user viewing a broadcast program may readjust the image quality adjustment value to an appropriate value if the cause that the image quality has degraded after the channel switching is due to the image quality adjustment value of the digital broadcast apparatus. However, a setting screen in related art is configured such that only the setting information corresponding to an individual input source is displayed as shown in FIG. 2. For example, there is configured such that the display screen is changed so that the setting information corresponding to other input source is displayed. Thus, in order to compare the adjustment value of the terrestrial digital broadcasting with the adjustment value of the BS digital broadcasting, it is necessary to write down the adjustment value of the terrestrial digital broadcasting displayed on the screen and then to switch the screen for comparing the written value with the adjustment value of the BS digital broadcasting on the screen.

The user would view the BS digital broadcasting with low image quality without making the above complicated comparison. Consequently, it is difficult to determine whether the degradation in video quality occurring when switching from the terrestrial digital broadcasting to the BS digital broadcasting is due to the image quality adjustment value of the digital broadcast apparatus or a video distributing technique different for each input source. Furthermore, with the setting screen configuration shown in FIG. 2, it is difficult to set the image quality adjustment value of the BS digital broadcasting while referring to the setting information of the terrestrial digital broadcasting. However, the same image quality adjustment value is set for the input sources which transmit a video signal in the same transmission system in many cases. Further, only the image quality adjustment values corresponding to some input sources may be finely adjusted after the same image quality adjustment value for several input sources has been set.

From the above reasons, there is required a displaying technique for easily comparing and referring to the items of setting information corresponding to a plurality of input sources. In the embodiment described later, there is proposed a technique for displaying a plurality of items of setting information in a list so as to easily compare the items of setting information for different input sources in a digital broadcast apparatus for several input sources. Further, there is proposed a technique capable of replicating the setting information displayed in a list or easily making fine adjustment of some items of setting information.

### Embodiment

One embodiment according to the present invention will be described. The present embodiment relates to a technique for effectively presenting the setting information such as image quality adjustment values corresponding to a plurality of input sources to the user. In particular, the present embodiment relates to a displaying method which enables the user to easily compare several items of setting information. Further, in the present embodiment, there is proposed a user interface and edition processing method capable of efficiently editing the setting information based on the comparison result.

### 2. SYSTEM CONFIGURATION OF VIDEO DISPLAYING SYSTEM

At first, a system configuration of the video displaying system according to the present embodiment will be described with reference to FIG. 3. FIG. 3 is an explanatory diagram showing a system configuration example of the video displaying system according to the present embodiment. The external devices exemplified in FIG. 3 are merely exemplary and the configuration of the external devices included in the video displaying system is not limited thereto.

As shown in FIG. 3, the video displaying system includes a video displaying apparatus 100, a recording/reproducing apparatus 10, a video reproducing apparatus 20 and a memory 30. The recording/reproducing apparatus 10, the video reproducing apparatus 20 and the memory 30 are examples of external device.

At first, the external devices will be described.

The recording/reproducing apparatus 10 is an apparatus for receiving various broadcast waves to record video signals or outputting the recorded video signals. For example, the recording/reproducing apparatus 10 mounts thereon an optical recording apparatus, magnetooptical recording apparatus, magnetic recording apparatus, semiconductor recording apparatus or the like. A video signal is recorded in the recording apparatuses. Further, the recording/reproducing apparatus 10 is connected to the video displaying apparatus 100 to transmit a video signal to the video displaying apparatus 100. The video displaying apparatus 100 and the recording/reproducing apparatus 10 are connected via a HDMI cable, for example. The above HDMI is an abbreviation of High-Definition Multimedia Interface. When a video signal is transmitted from the recording/reproducing apparatus 10 to the video displaying apparatus 100, the video signal is displayed on the video displaying apparatus 100.

The video reproducing apparatus 20 is an apparatus for reading out video data recorded in an optical disk, a semiconductor memory or the like via an optical disk drive, a memory reader or the like, and outputting a video signal corresponding to the video data. The optical disk employs DVD media, Blu-ray media and the like, for example. The above DVD is an abbreviation of Digital Versatile Disc. The video reproducing apparatus 20 is connected to the video displaying apparatus 100 similarly as the recording/reproducing apparatus 10. Thus, a video signal output from the video reproducing apparatus 20 is transmitted to the video displaying apparatus 100. When a video signal is transmitted from the video reproducing apparatus 20 to the video displaying apparatus 100, the video signal is displayed on the video displaying apparatus 100.

The video displaying apparatus 100 mounts thereon a memory slot, a USB terminal and the like to which the memory 30 is connectable. The USB is an abbreviation of Universal Serial Bus. The memory 30 records therein image data, video data and the like. Thus, when the memory 30 is connected to the video displaying apparatus 100, the image data, the video data and the like are read out from the memory 30 and displayed on the screen of the video displaying apparatus 100. The video displaying apparatus 100 is input with video data from an external device connected thereto via a network such as DLAN. The above DLAN is an abbreviation of Digital Living Network Alliance.

The video displaying apparatus 100 will be described below.

As described above, a plurality of external devices are connected to the video displaying apparatus 100. Further, the video displaying apparatus 100 is input with the terrestrial digital broadcast signal, the BS digital broadcast signal and the like. Of course, the video displaying apparatus 100 may be configured to be input with the CS digital broadcast signal, the terrestrial analog broadcast signal, the cable television broadcast signal and the like. In this manner, a broadcast wave distribution source, several external devices and network-connected external devices are present as the input source of the video displaying apparatus 100.

The present embodiment relates to a technique capable of efficiently setting the setting information corresponding to an individual input source also when many input sources are present. In particular, the present embodiment relates to a method for performing display control on the setting screen in the video displaying apparatus 100. In the following, a technical configuration of the video displaying apparatus 100 will be described in detail in consideration of the system configuration of the video displaying system shown in FIG. 3. An applicable range of the technique according to the present embodiment is not limited to the system configuration exemplified in FIG. 3. It is noted that the system configuration shown in FIG. 3 is merely one example.

### 3: HARDWARE CONFIGURATION EXAMPLE OF VIDEO DISPLAYING APPARATUS 100

A hardware configuration example of the video displaying apparatus 100 according to the present embodiment will be first described with reference to FIG. 4. The functional configuration of the video displaying apparatus 100 described later is realized in the hardware configuration shown in FIG. 4, for example. FIG. 4 is an explanatory diagram showing the hardware configuration of the video displaying apparatus 100 according to the present embodiment.

As shown in FIG. 4, the video displaying apparatus 100 includes a plurality of reception circuits 102, 104, a plurality of demultiplexers 106, 110 and a descramble unit 108. Further, the video displaying apparatus 100 includes an audio processing unit 112, a data processing unit 114, a video processing unit 116, an OSD circuit 118 and a combination circuit 120. The video displaying apparatus 100 also mounts thereon a display unit 122 and a controller 124. The above OSD is an abbreviation of On Screen Display.

In this manner, the video displaying apparatus 100 is provided with two types of reception circuit 102, 104. The two demultiplexers 106 and 110 are provided for each type of reception circuit 102, 104, respectively. For example, the reception circuit 102 is directed for receiving an additional information signal of data information or the like on a broadcast program. On the other hand, the reception circuit 104 is directed for receiving a program broadcast signal corresponding to video data or audio data of a broadcast program. As shown in FIG. 4, the reception circuit 102 includes a tuner 132, a demodulation unit 134 and an error correction unit 136. Similarly, the reception circuit 104 includes a tuner 142, a demodulation unit 144 and an error correction unit 146.

Further, the controller 124 is a control means for performing control processings of the video displaying apparatus 100. As shown in FIG. 4, the controller 124 includes a CPU 152, a ROM 154, a RAM 156, an EEPROM 158, a DRAM 160 and a bus 162. The CPU 152, the ROM 154, the RAM 156, the EEPROM 158 and the DRAM 160 are interconnected via the bus 162.

The above CPU is an abbreviation of Central Processing Unit. The above ROM is abbreviation of Read Only Memory. The above RAM is an abbreviation of Random Access Memory. The above EEPROM is an abbreviation of Electrically Erasable Programmable ROM. Further, the above DRAM is an abbreviation of Dynamic RAM.

When the power supply of the video displaying apparatus 100 is turned ON, a processing of receiving an additional information signal is started via the reception circuit 102. Along with this, the video displaying apparatus 100 starts a processing of receiving a program broadcast signal via the reception circuit 104. When the additional information signal and the program broadcast signal are received, the video displaying apparatus 100 decodes a video signal, a audio signal, a data signal and the like from these signals, and outputs the decoded signals to the display unit 122 and a audio output unit (not shown). The audio output unit may be incorporated in the display unit 122 or externally attached to the display unit 122. In the following, there will be described a processing from the power ON until the video signal is output to the display unit 122.

At first, when the video displaying apparatus 100 is powered, the controller 124 reads out broadcast information of a program broadcast signal which has been received until just before the shutoff of the power supply from the EEPROM 158 and selects a channel again. It is assumed that at the time of the shutoff of the power supply, the broadcast information such as channel frequency or program ID of the program broadcast signal received until just before the shutoff of the power supply is held in the EEPROM 158. When the channel frequency is determined by the controller 124 based on the broadcast information, a channel tuning control signal for selecting the channel frequency is output to the reception circuit 104. The channel tuning control signal is input into the tuner 142 included in the reception circuit 104.

The tuner 142 selects a channel based on the channel tuning control signal input from the controller 124 and receives a program broadcast signal of the channel frequency indicated by the channel tuning control signal. The program broadcast signal received by the tuner 142 is input into the demodulation unit 144. The demodulation unit 144 demodulates the input program broadcast signal. The program broadcast signal has been modulated in the multilevel modulation system of 64QAM, for example. Thus, the demodulation unit 144 demodulates the program broadcast signal based on the system and generates a transport stream signal. The transport stream signal generated by the demodulation unit 144 is input into the error correction unit 146.

When the transport stream signal is input, the error correction unit 146 makes an error correction to the input transport stream signal. The transport stream signal is encoded by a Reed-Solomon code or the like, for example. Thereby, the error correction unit 146 performs the error correction processing based on the encoding system. The transport stream signal subjected to the error correction, which has been output from the error correction unit 146, is input into the descramble unit 108.

When the transport stream signal subjected to the error correction is input, the descramble unit 108 descrambles the transport stream signal. At this time, the descramble unit 108 descrambles the signal based on the information acquired from the controller 124 and reproduces the original program broadcast signal. The original program broadcast signal descrambled and reproduced by the descramble unit 108 is input into the demultiplexer 110.

The program broadcast signal is multiplexed with a video signal, a audio signal, a data signal and the like. When the program broadcast signal is input, the demultiplexer 110 separates the video signal, the audio signal, the data signal and the like contained in the program broadcast signal. The audio signal separated by the demultiplexer 110 is input into the audio processing unit 112. The data signal separated by the demultiplexer 110 is input into the data processing unit 114. Further, the video signal separated by the demultiplexer 110 is input into the video processing unit 116.

The audio processing unit 112 outputs an audio to the audio output unit based on the input audio signal. Further, the data processing unit 114 converts text information or image information contained in the input data signal into a video signal displayable on the display unit 122. The video signal output from the data processing unit 114 is input into the combination unit 120. On the other hand, the video processing unit 116 performs a predetermined processing on the input video signal to input the same into the combination circuit 120. Furthermore, the combination circuit 120 may be input with a video signal for displaying an OSD image from the OSD circuit 118 on the display unit 122.

The OSD circuit 118 generates a video signal for displaying an electronic program guide, various guidance messages and the like under control of the controller 124. The OSD circuit 118 generates a video signal for displaying a setting screen for image quality or audio. As described above, the video signal generated by the OSD circuit is input into the combination circuit 120. The combination circuit 120 combines the video signals input from the data processing unit 114, the video processing unit 116 and the OSD circuit 118. The video signal combined by the combination circuit 120 is input into the display unit 122. The display unit 122 displays the input video signal on the screen.

There have been described above the processing steps until a video is displayed on the display unit 122. Next, there will be described briefly a step of processing an additional information signal received by the reception unit 102.

As described above, the controller 124 inputs a channel tuning control signal into the tuner 142 of the reception circuit 104 in order to receive a program broadcast signal. At this time, the controller 124 inputs the same channel tuning control signal also into the tuner 132 of the reception circuit 102. When the channel tuning control signal is input, the tuner 132 sets a channel frequency indicated by the input channel tuning control signal at a reception frequency and receives an additional information signal. The additional information signal received by the tuner 132 is input into the demodulation unit 134. The demodulation unit 134 demodulates the input additional information signal and inputs the same into the error correction unit 136. The error correction unit 136 makes an error correction to the additional information signal and inputs the same into the demultiplexer 106.

The demultiplexer 106 extracts additional information contained in the input additional information signal and inputs the same into the controller 124. The additional information includes program information such as electronic program guide as one example. The controller 124 temporarily records the additional information extracted by the demultiplexer 106 in the DRAM 160. Then, the controller 124 provides an additional information service such as electronic program guide to the user based on the additional information recorded in the DRAM 160. At this time, when a broadcast program is designated by the user, the controller 124 inputs a channel tuning control signal for selecting the designated program into the reception circuit 102 or the reception circuit 104. The processing step after the channel tuning control signal has been input is similar as the above processing.

There has been described above the hardware configuration example of the video displaying apparatus 100 according to the present embodiment briefly. The hardware configuration of the video displaying apparatus 100 shown in FIG. 4 is merely one example, and an apparatus form to which the technique according to the present embodiment is applicable is not limited thereto.

### 4: FUNCTIONAL CONFIGURATION OF VIDEO DISPLAYING APPARATUS 100

Next, a functional configuration of the video displaying apparatus 100 according to the present embodiment will be described with reference to FIG. 5. FIG. 5 is an explanatory diagram showing a functional configuration example of the video displaying apparatus 100 according to the present embodiment. The number or specific kind of video signal input sources may be changed.

As shown in FIG. 5, the video displaying apparatus 100 mainly includes video reception units 202, 204, an external device connection unit 206, a network reception unit 208 and a display control unit 210. The display control unit 210 includes a storage unit 212. Further, the video displaying apparatus 100 includes the display unit 122, an operation input unit 216, a setting information management unit 218, a difference setting detection unit 220 and an arrangement order table storage unit 222.

### (Function of Input Source)

The video reception unit 202 is a means for receiving a broadcast wave of the terrestrial digital broadcasting, for example. Similarly, the video reception unit 204 is a means for receiving a broadcast wave of the BS digital broadcasting, for example. The broadcast wave received by the video reception unit 202, 204 is converted into a video signal to be input into the display control unit 210. Further, the external device connection unit 206 is a connection terminal for connecting an external device thereto. The external device connection unit 206 is connected with the external device such as the recording/reproducing apparatus 10, the video reproducing apparatus 20 or the memory 30. Thus, the video signal output from the external device is input into the display control unit 210 via the external device connection unit 206.

The network reception unit 208 is a means for receiving a video signal via a network such as DLAN. For example, the network reception unit 208 issues a request of transmitting a video signal to a video distribution server connected to the network, and acquires the streaming-distributed video signal via a predetermined authentication processing or the like. The network reception unit 208 may be configured to access a video data server connected to the network for downloading the video data and to output a video signal corresponding to the downloaded video data. The network reception unit 208 may be configured to acquire program information on broadcast program and the like from an information providing server over a wide area network. The video signal output from the network reception unit 208 is input into the display control unit 210.

### (Display Control Function)

When a video signal is input from an individual input source into the display control unit 210, the display control unit 210 displays the input video signal on the display unit 122. At this time, the display control unit 210 adjusts an image quality of the video signal or a display setting of the display unit 122 for display based on the setting information set for each input source. The setting information set for each input source is recorded in the storage unit 212. For example, the storage unit 212 records therein the setting information as shown in FIG. 6. FIG. 6 shows the setting information set for each input source. For example, for the image quality adjustment value for an individual input source, the setting items such as brightness, color shade, sharpness and double speed drive are specifically set. For the sound quality adjustment value, the setting items such as high tone, low tone and surround are specifically set.

The categorization of the setting information shown in FIG. 6 is merely one example and an applicable range of the technique according to the present embodiment is not limited thereto. The setting information is categorized for each type of broadcast wave in the example of FIG. 6, but the terrestrial digital broadcasting and the BS digital broadcasting may be assigned to the same category of setting information together. Further, the broadcast waves may be configured as one category or the external devices may be configured as one category. Further, the categorization may be made depending on a signal encoding form, a distribution form or the like. If the image quality characteristics of the video signals distributed in the same form are similar, the input sources from which the video signals are distributed in the same form are assigned to the same category so that setting works for the input sources belonging to the same category can be achieved at a time, thereby reducing a working load on the user. Thus, many variants are possible for the recording form of the setting information recorded in the storage unit 212.

With reference to FIG. 5 again, as described above, the setting information to be recorded in the storage unit 212 is set by the user. The storage unit 212 records therein predetermined setting information corresponding to each input source as an initial value. Thus, the user's setting work is performed in a form of first changing the initial value. Further, the user uses the operation input unit 216 to perform an operation of setting the setting information. For example, a remote controller employed for channel tuning or sound volume adjustment is used as the operation input unit 216. The shape or input form of the operation input unit 216 may be variously changed. For example, the operation input unit 216 may be a keyboard, a mouse or the like used in a personal computer and the like, or may be a controller used in a home game device and the like.

When a user's instruction of displaying the display screen of the setting information is input via the operation input unit 216, the display control unit 210 reads out the setting information corresponding to each input source from the storage unit 212 and displays the same in a list on the display unit 122. At this time, the display control unit 210 inquires of the setting information management unit 218 for the kind of the setting information to be displayed on the display unit 122 and then displays the setting information on the display unit 122 based on the response contents of the setting information management unit 218. For example, the setting information management unit 218 responds to the display control unit 210, in response to the inquiry from the display control unit 210, about the kinds of the setting information to be displayed and the arrangement order of display items contained in each item of setting information in consideration of the number of items of setting information displayable on the display unit 122. Then, the display unit 122 displays thereon a plurality of items of setting information in a list based on the response contents.

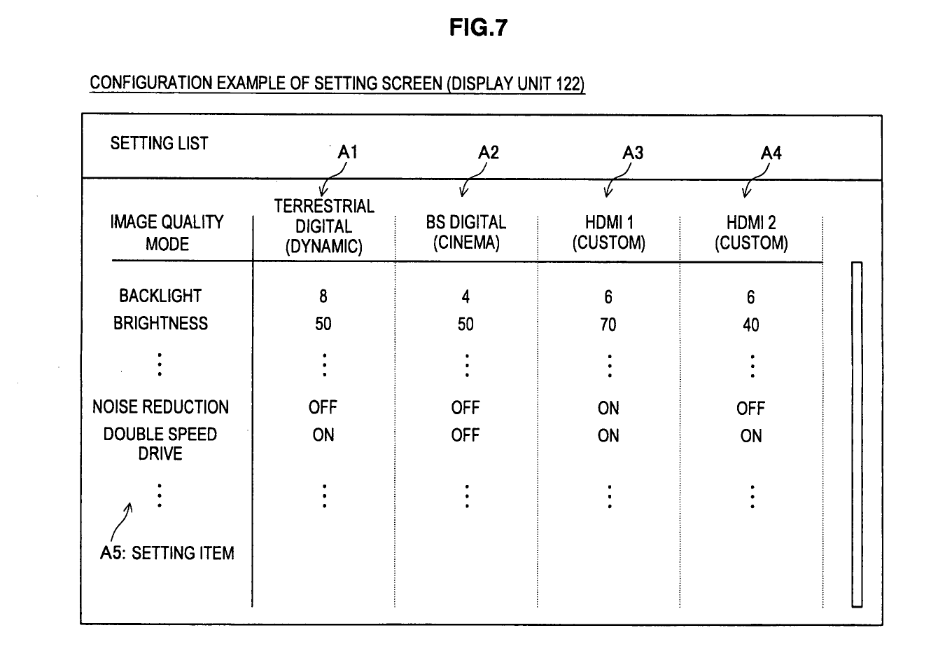

For example, the display unit 122 displays thereon a setting screen as shown in FIG. 7. As shown in FIG. 7, the setting screen displayed on the display unit 122 contains the setting information corresponding to a plurality of input sources (A1, A2, A3, A4). In the example of FIG. 7, the setting information is displayed to be categorized for each image quality mode. As described previously, the setting information is arbitrarily categorized and may be categorized for each image quality mode as shown in FIG. 7. The image quality mode includes dynamic, cinema, custom and the like, for example. Dynamic is, for example, a preset image quality mode suitable for dynamic videos such as sport scene. Cinema is a preset image quality mode suitable for dark videos such as movie. Custom is an image quality mode freely set by the user, for example.

The setting information is provided with many setting items. The setting items include backlight, brightness, noise reduction, double speed drive and the like, for example. Backlight is an item for setting an adjustment value of a backlight mounted on the display unit 122. Brightness is an item for setting an adjustment value of the brightness of the video signal. Noise reduction is an item for setting whether to perform a noise reduction processing on a video signal. Double speed drive is an item for setting whether to set a frame rate of a video signal at double or four times. In this manner, many setting items are provided. The setting information may be provided with some items for sound quality in addition to the items for image quality.

As exemplified in FIG. 7, the display control unit 210 displays a plurality of items of setting information in a list on the display unit 122. Thus, the user can mutually compare the items of setting information for different input sources. As a result, it is possible to easily determine whether a change in image quality occurring before and after the switching of an input source is due to a difference in setting information. Further, it is possible to, when changing the setting information corresponding to one input source, refer to the setting information corresponding to other input source. Thus, when a plurality of items of setting information are set at the same adjustment value, the user does not need to switch the setting screen for each item of setting information or to write down an adjustment value as reference source. Consequently, the setting information adjusting work is made efficient, thereby largely improving user's convenience.

However, there is limited the number of items of setting information capable of being displayed in a list on the display unit 122 at one time. When many items of setting information are displayed in a list, if the setting information as reference source and the setting information as reference destination are displayed to be distant from each other, the both items of setting information are difficult to compare and the adjustment value as reference source may be mistaken. From the above reasons, it is required to appropriately determine the arrangement order of the items of setting information to be displayed on the setting screen and the arrangement order of the setting items. The main processings for the determination of the items of setting information to be displayed on the display unit 122, the determination of the arrangement order of the items of setting information and the determination of the arrangement order of the setting items are performed by the setting information management unit 218. In the following, the functional configurations of these processings will be described.

FIG. 5 will be referred to again. As described above, the setting information management unit 218 is a means for performing the processing of determining the items of setting information to be displayed on the display unit 122, the processing of determining the arrangement order of the items of setting information, and the processing of determining the arrangement order of the setting items. In the following, the determination processings will be individually described. It is assumed that the setting information management unit 218 is input with a plurality of items of setting information recorded in the storage unit 212 from the display control unit 210.

### (Determination of Setting Information and Determination of Arrangement Order of Setting Information)

There will be first described the processing of determining the items of setting information to be displayed on the display unit 122. As described previously, the number of items of setting information displayable on the display unit 122 is limited. In the example of FIG. 7, the display region of the display unit 122 is full of the items of setting information corresponding to four input sources. If there are present the items of setting information corresponding to five or more input sources, it is necessary to determine four items of setting information to be displayed on the display unit 122 therefrom. The setting information management unit 218 determines the items of setting information to be displayed on the display unit 122 as follows.

At first, the setting information management unit 218 determines the kinds (input sources) of the setting information to be displayed at the first column of the setting screen. The first column may be arbitrarily set at a reference position within the setting screen. It is assumed that the (N+1)-th column is arranged next to the N-th column (N is a natural number). For example, if a video signal has been displayed on the display unit 122 when the display operation of the setting screen is performed, the setting information management unit 218 assigns the setting information of the input source corresponding to the video signal to the first column. When the user has designated to display a predetermined input source at the first column, the setting information management unit 218 assigns the setting information of the designated input source at the first column.

Next, the setting information management unit 218 inputs an adjustment value of the setting information assigned to the first column as a reference value into the difference setting detection unit 220. Further, the setting information management unit 218 inputs the adjustment values of all the items of setting information different from the setting information at the first column into the difference setting detection unit 220. The difference setting detection unit 220 individually compares the adjustment values of the other items of setting information with the reference value and orders the other items of setting information in descending order of the difference relative to the reference value. For example, the difference setting detection unit 220 calculates a difference between the adjustment value of each setting item input as the reference value and the adjustment value of each setting item contained in other setting information, and adds the absolute value of the difference to all the setting items. When the added value is calculated for all the other items of setting information, the difference setting detection unit 220 orders the other items of setting information in descending order of the added value. Then, the difference setting detection unit 220 inputs the information on the order of all the other items of setting information into the setting information management unit 218.

When the information on the order is input from the difference setting detection unit 220, the setting information management unit 218 assigns the setting information in the highest order to the second column, and assigns the setting information in the next highest order to the third column. In other words, the difference setting detection unit 220 assigns the setting information in descending order from the first column. When a displayable number of items of setting information are assigned on the display unit 122, the information representing the combination of the items of setting information to be displayed on the display unit 122 and the display order is input as the response contents from the setting information management unit 218 to the display control unit 210. Thus, the display control unit 210 displays the setting information on the display unit 122 based on the response contents acquired from the setting information management unit 218.

With the above configuration, in the display unit 122, the setting information having a large difference relative to the reference setting information is displayed close to the reference setting information. Thus, the items of setting information to be compared are closely arranged so that the adjustment values to be compared may be less likely mistaken. The setting information having an adjustment value largely different from the reference setting information is first displayed on the display unit 122. Typically, since the setting information whose image quality satisfies the user is set as a reference, the setting information largely different from the reference setting information is to be adjusted with higher possibility. Thus, even if the user does not sequentially retrieve one item of setting information to be adjusted, the setting information is first displayed, thereby making the setting work efficient.

### (Determination of Arrangement Order of Setting Items)

Next, there will be described the processing of determining the arrangement order of the setting items contained in an individual item of setting information. At first, the setting information management unit 218 determines the arrangement order of the setting items based on the setting information displayed at the first column of the setting screen. At this time, the setting information management unit 218 refers to an arrangement order table recorded in the arrangement order table storage unit 222. The arrangement order table describes therein an arrangement order of the setting items for each kind of input source or image quality mode. Thus, the setting information management unit 218 refers to the arrangement order table and extracts the arrangement order data corresponding to the kind of input source corresponding to the setting information at the first column or the image quality mode. Then, the setting information management unit 218 determines the arrangement order indicated by the extracted data as the arrangement order of the setting items displayed on the setting screen.

Furthermore, the setting information management unit 218 may be configured to compare the adjustment value of each setting item contained in the setting information at the first column with the adjustment value of each setting item contained in the setting information at the second column and then to arrange the setting items in descending order of the difference in adjustment value. With the above configuration, in the example of FIG. 7, the setting information management unit 218 can determine the arrangement order such that the setting item for backlight and the setting item for double speed drive are in higher order and the setting items for brightness and noise reduction are in lower order. When the setting information is adjusted, an item having a largely different adjustment value is to be adjusted. A setting item having a large difference relative to the reference setting information is displayed in higher order so that the item to be set is obviously apparent to shorten the time to search for the item to be set by the user.

The arrangement order information representing the arrangement order of the setting items determined by the setting information management unit 218 is input into the display control unit 210. When the arrangement order information is input, the display control unit 210 arranges the setting items of the setting information to be displayed on the display unit 122 based on the arrangement order information and displays the same on the display unit 122. In this manner, it is possible not only to display a plurality of items of setting information in a list but also to perform rearrangement so as to rapidly retrieve a user-desired setting item, thereby making the setting work remarkably efficient and reducing a load on the user for setting operation.

### (Replication of Setting Information)

Next, there will be briefly described a processing of replicating the setting information by the display control unit 210. The outline of main operator and processing of the replication processing will be described here and the details thereof will be described later.

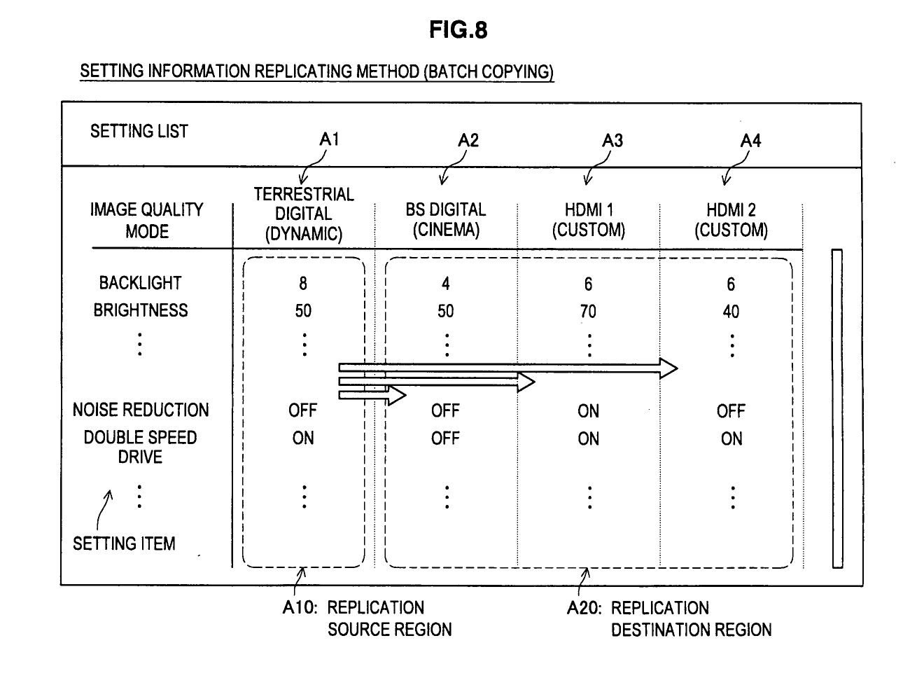

As described above, the display control unit 210 displays a plurality of items of setting information corresponding to a plurality of input sources in a list. Consequently, it is possible to arrange the items of setting information corresponding to different input sources and to refer to the same while mutually comparing them, and the user's work of adjusting the setting information is made efficient. When the number of items to be set is remarkably large or when the number of input sources for which the same setting information is to be set is large, a large effort is required to input the adjustment values into the individual setting items. Thus, in such a case, even if the display configuration in which a plurality of items of setting information can be compared and referred to each other is employed, a large working load will be imposed on the user. There is thus proposed a setting information replicating method shown in FIGS. 8 to 11 in the present embodiment. A series of processings for the replicating method is performed by the display control unit 210. In the following, the replicating method will be described in detail.

### 5: SETTING INFORMATION REPLICATING METHOD

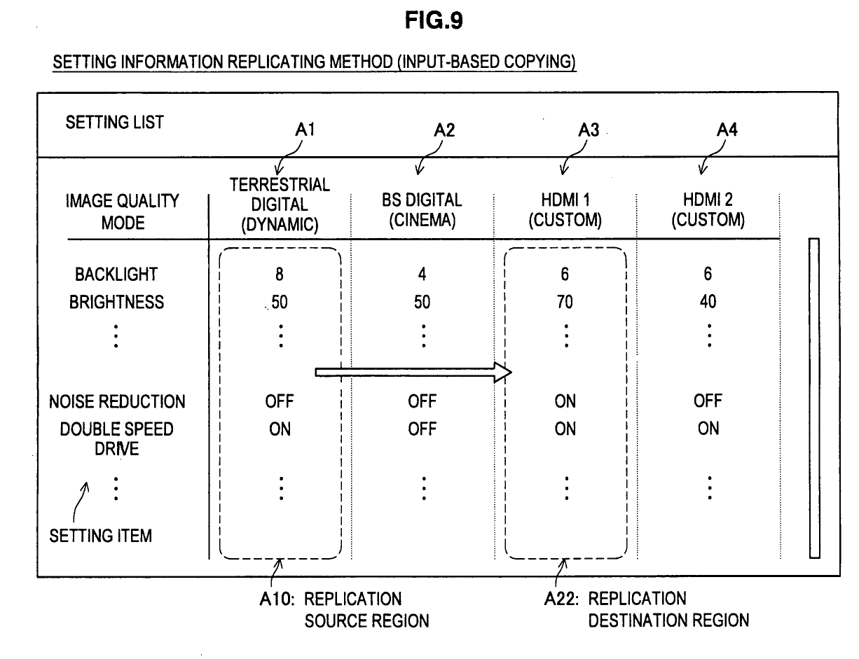

The setting information replicating method according to the present embodiment will be described with reference to FIGS. 8 to 11. FIG. 8 is an explanatory diagram showing a batch copying method for replicating one item of setting information to all the items of setting information. FIG. 9 is an explanatory diagram showing an input-based copying method for performing the replication processing for the designated setting information when the setting information as replication source and the setting information as replication destination are designated based on the input source (image quality mode).

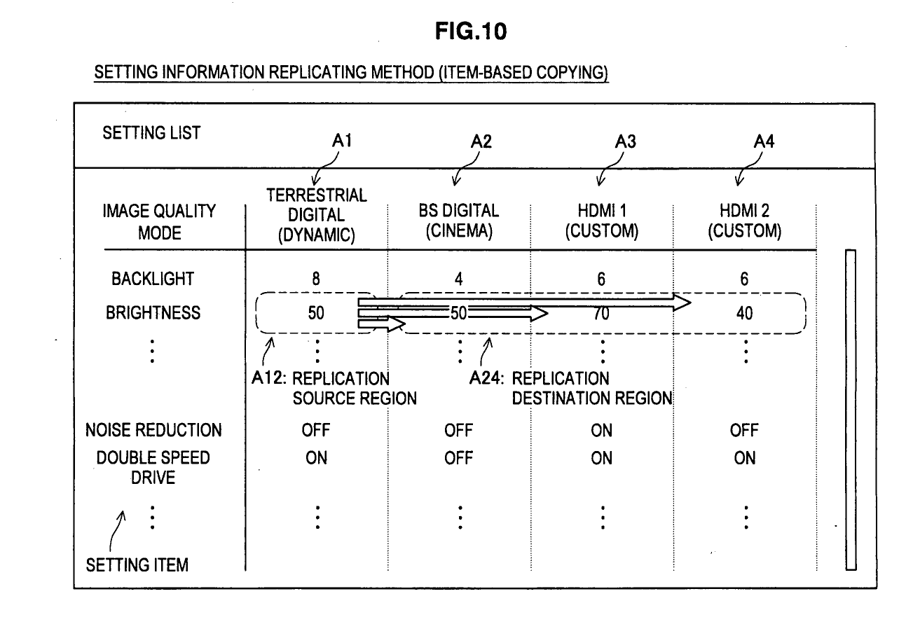

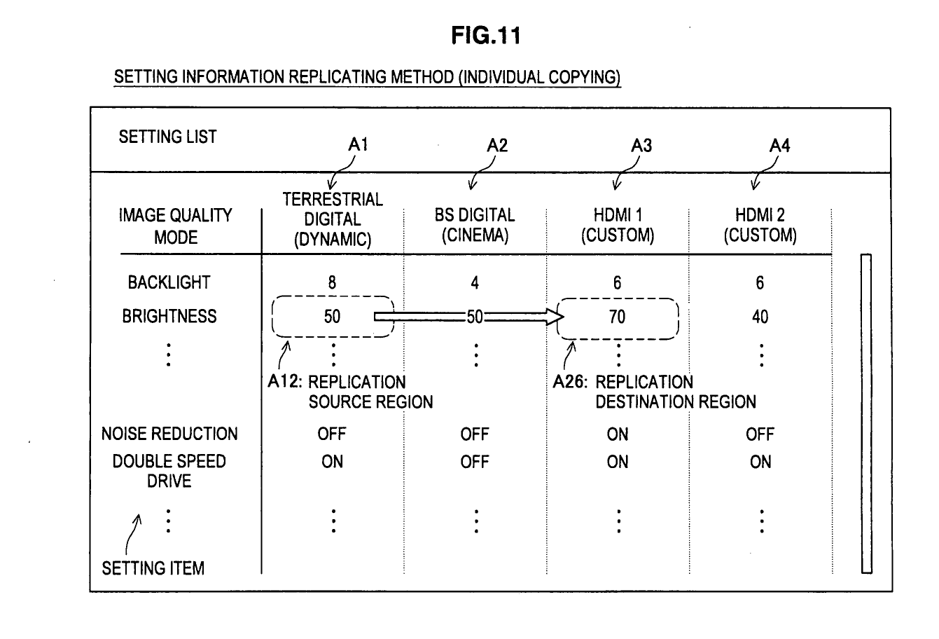

FIG. 10 is an explanatory diagram showing an item-based copying method for replicating one setting item contained in one item of setting information to the same setting item contained in all the other items of setting information. FIG. 11 is an explanatory diagram showing an individual copying method for performing the replication processing on the same setting item contained in the designated setting information when one setting items contained in the setting information as replication source and the setting information as replication destination are designated. In the following, these methods will be described in order.

### (Batch Copying Method)

At first, FIG. 8 will be referred to. FIG. 8 shows the setting screen to be displayed on the display unit 122. In the example of FIG. 8, setting information A1 displayed at the first column is designated as a replication source region A10. The operation of designating the replication source region A10 is performed by the user via the operation input unit 216. When the operation of designating the replication source region A10 is performed by the user, an operation signal of the designation operation is input from the operation input unit 216 to the display control unit 210 and the replication source region A10 is clearly displayed on the setting screen by the display control unit 210. The display control unit 210 may be configured to automatically designate the reference setting information to be displayed at the first column as the replication source region A10.

In the example of FIG. 8, all the setting items contained in the items of setting information (A2, A3, A4) are designated as a replication destination region A20. In the case of the batch copying, the replication destination region A20 is automatically designated by the display control unit 210. For example, the display control unit 210 designates all the items of setting information (A2, A3, A4) other than the setting information A1 displayed at the first column from among the items of setting information (A1, A2, A3, A4) displayed on the setting screen as the replication destination region A20. The designated replication destination region A20 is clearly displayed on the setting screen by the display control unit 210. The display control unit 210 may be configured to designate the setting information which is not displayed on the setting screen in a list as the replication destination region A20.

Furthermore, when there is present the setting information protected against the edition processing, the display control unit 210 may be configured to designate all the items of setting information other than the protected setting information as the replication destination region A20. When the replication source region A10 and the replication destination region A20 are designated in the above manner, the display control unit 210 writes the adjustment values of the setting items contained in the replication source region A10 as the adjustment values of the setting items of all the items of setting information contained in the replication destination region A20. The display control unit 210 may be configured to perform the processing of replicating the setting information in response to an instruction of performing the replication processing input via the operation input unit 216.

With the above configuration, when one item of setting information is desired to be replicated to a plurality of items of setting information, the adjustment value does not need to be manually input into the setting items one by one, thereby remarkably reducing the working load on the user. Fine adjustment is made on only part of the items of setting information after a plurality of items of setting information are set at the same adjustment value by the batch copying, so that the input work can be omitted for the items of setting information which are common in large part, thereby largely improving user's convenience.

### (Input-Based Copying Method)

Next, FIG. 9 will be referred to. FIG. 9 shows the setting screen to be displayed on the display unit 122. In the example of FIG. 9, the setting information A1 displayed at the first column is designated as the replication source region A10. The operation of designating the replication source region A10 is performed by the user via the operation input unit 216. When the operation of designating the replication source region A10 is performed by the user, an operation signal of the designation operation is input from the operation input unit 216 to the display control unit 210 and the replication source region A10 is clearly displayed on the setting screen by the display control unit 210. The display control unit 210 may be configured to automatically designate the reference setting information to be displayed at the first column as the replication source region A10.

In the example of FIG. 9, all the setting items contained in the setting information A3 are designated as a replication destination region A22. In the case of the input-based copying, the replication destination region A22 is not automatically designated by the display control unit 210 but is designated via a user's operation. For example, there is displayed a designation object for designating the replication destination region A22 by the display control unit 210 on the setting screen. Thus, the user uses the operation input unit 216 to move the position of the designation object and to perform the designation operation when the designation object is displayed at the position of desired setting information. At this time, all the setting items contained in the designated setting information are designated.

In the example of FIG. 9, all the setting items contained in the setting information A3 among the items of setting information (A1, A2, A3, A4) displayed on the setting screen are designated as the replication destination region A22. The designated replication destination region A22 is clearly displayed on the setting screen by the display control unit 210. When the replication source region A10 and the replication destination region A22 are designated in the above manner, the display control unit 210 writes the adjustment values of the setting items contained in the replication source region A10 as the adjustment values of all the setting items of the setting information contained in the replication destination region A22. The display control unit 210 may be configured to perform the processing of replicating the setting information in response to an instruction of performing the replication processing input via the operation input unit 216.

With the above configuration, when all the setting items contained in one item of setting information are desired to be replicated to the other item of setting information, the adjustment values does not need to be manually input into the setting items one by one, thereby remarkably reducing the working load on the user. Further, fine adjustment is made on only part of the setting items after the same adjustment value is set for all the setting items contained in the setting information by the input-based copying, so that the input work can be omitted for the setting items which are common in large part, thereby largely improving user's convenience:

### (Item-Based Copying Method)

Next, FIG. 10 will be referred to. FIG. 10 shows the setting screen to be displayed on the display unit 122. In the example of FIG. 10, one setting item contained in the setting information A1 displayed at the first column is designated as the replication source region A12. The operation of designating the replication source region A12 is performed by the user via the operation input unit 216. When the operation of designating the replication source region A12 is performed by the user, an operation signal of the designation operation is input from the operation input unit 216 to the display control unit 210 and the replication source region A12 is clearly displayed on the setting screen by the display control unit 210.

In the example of FIG. 10, the setting items which are contained in the items of setting information (A2, A3, A4) and correspond to the replication source region A12 are designated as a replication destination region A24. In the case of the item-based copying, the replication destination region A24 is automatically designated by the display control unit 210. For example, the display control unit 210 designates the above setting items of all the items of setting information (A2, A3, A4) other than the setting information A1 displayed at the first column from among the items of setting information (A1, A2, A3, A4) displayed on the setting screen. The designated replication destination region A24 is clearly displayed on the setting screen by the display control unit 210. The display control unit 210 may be configured to designate the setting items of the items of setting information which are not displayed in a list on the setting screen as the replication destination region A24.

Furthermore, when there is present the setting information protected against the edition processing, the display control unit 210 may be configured to designate the above setting items of all the items of setting information other than the protected setting information as the replication destination region A24. When the replication source region A12 and the replication destination region A24 are designated in this manner, the display control unit 210 writes the adjustment value of the setting item designated as the replication source region A12 as the adjustment values of all the setting items contained in the replication destination region A24. The display control unit 210 may be configured to perform the processing of replicating the setting item in response to an instruction of performing the replication processing input via the operation input unit 216.

With the above configuration, when the adjustment value of one setting item contained in one item of setting information is desired to be replicated to a plurality of items of setting information, the adjustment value does not need to be manually input into the setting items one by one, thereby remarkably reducing the working load on the user. Fine adjustment is made on only part of the setting items after the same adjustment value is set for the setting items of the items of setting information by the item-based copying, so that the input work can be omitted for the setting items which are common in large part, thereby largely improving user's convenience.

### (Individual Copy)

Next, FIG. 11 will be referred to. FIG. 11 shows the setting screen to be displayed on the display unit 122. In the example of FIG. 11, one setting item contained in the setting information A1 displayed at the first column is designated as the replication source region A12. The operation of designating the replication source region A12 is performed by the user via the operation input unit 216. When the operation of designating the replication source region A12 is performed by the user, an operation signal of the designation operation is input from the operation input unit 216 to the display control unit 210 and the replication source region A12 is clearly displayed on the setting screen by the display control unit 210.

Furthermore, in the example of FIG. 11, the setting item which is contained in the setting information A3 and corresponds to the replication source region A12 is designated as a replication destination region A26. In the case of the individual copying, the replication destination region A26 is not automatically designated by the display control unit 210 but is designated via a user's operation. For example, a designation object for designating the replication destination region A26 by the display control unit 210 is displayed on the setting screen. Thus, the user uses the operation input unit 216 to move the position of the designation object and to perform the designation operation when the designation object is displayed at the position of a desired setting item. At this time, the designated setting item is designated.

In the example of FIG. 11, one setting item contained in the setting information A3 among the setting items displayed on the setting screen is designated as the replication destination region A26. The designated replication destination region A26 is clearly displayed on the setting screen by the display control unit 210. When the replication source region A12 and the replication destination region A26 are designated in the above manner, the display control unit 210 writes the adjustment value of the setting item designated for the replication source region A12 as the adjustment value of the setting item of the replication destination region A26. The display control unit 210 may be configured to perform the processing of replicating the setting item in response to an instruction of performing the replication processing input via the operation input unit 216.

With the above configuration, when the adjustment value of a certain setting item is desired to be replicated to other setting items, the adjustment value does not need to be manually input, thereby reducing the working load on the user and improving user's convenience.

The above replicating method according to the present embodiment advantageously improves user's convenience particularly when a simple operation means such as remote controller is employed for the operation input unit 216. As well known, it is not efficient to use a remote controller or the like to input a plurality of numbers or characters. Even if there is designed such that an adjustment value can be input in a menu selection system, the adjustment value may not be input without several processings such as displaying the menu, selecting a desired adjustment value from the menu, and performing a processing of inputting the selected adjustment value. Thus, when there are present many adjustment values to be set, many steps originate in operation of the user, thereby increasing a working load.

On the contrary, in the replicating method according to the present embodiment, an adjustment value can be replicated only by selecting one or two regions, a number of operation steps become much smaller than a number of operation steps in the menu selection system. Since it is not necessary to directly input an adjustment value, the user can perform the processing without stress even by a simple operation unit such as remote controller. Furthermore, even when the operation input unit 216 is a touch panel, a step of inputting numbers or characters is not involved so that the adjustment value input processing can be performed via an intuitive operation. There has been displayed the setting information of the input sources for actually inputting a video signal on the setting screen in the above example, but there may be configured such that the setting information as model is previously preset and the above replicating method is used to input an adjustment value.

There has been described above in detail the setting information replicating method according to the present embodiment with reference to specific screen configurations. There will be described below a flow of the replication processing by the display control unit 210.

### 6: FLOW OF SETTING INFORMATION REPLICATION PROCESSING

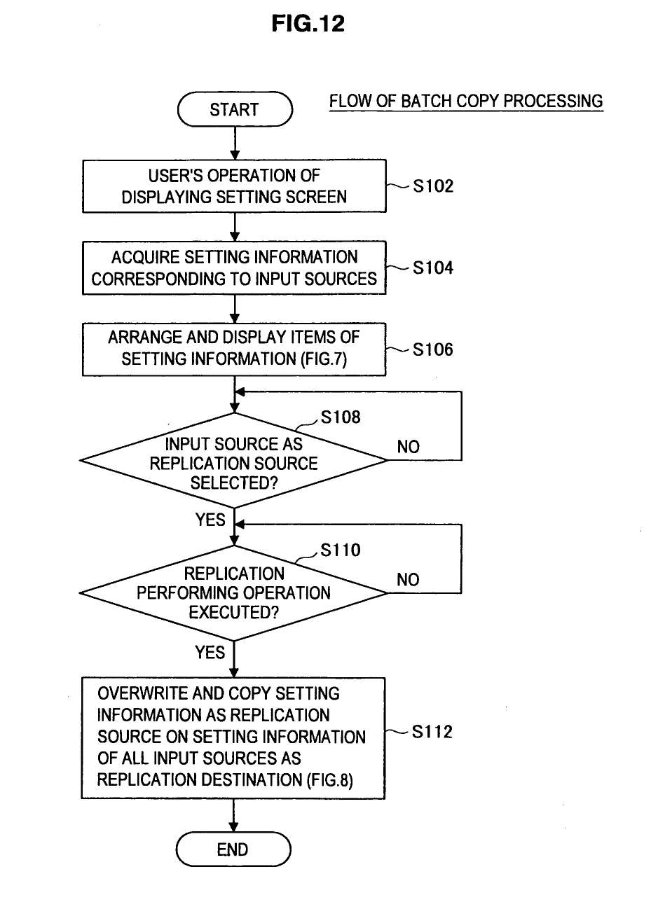

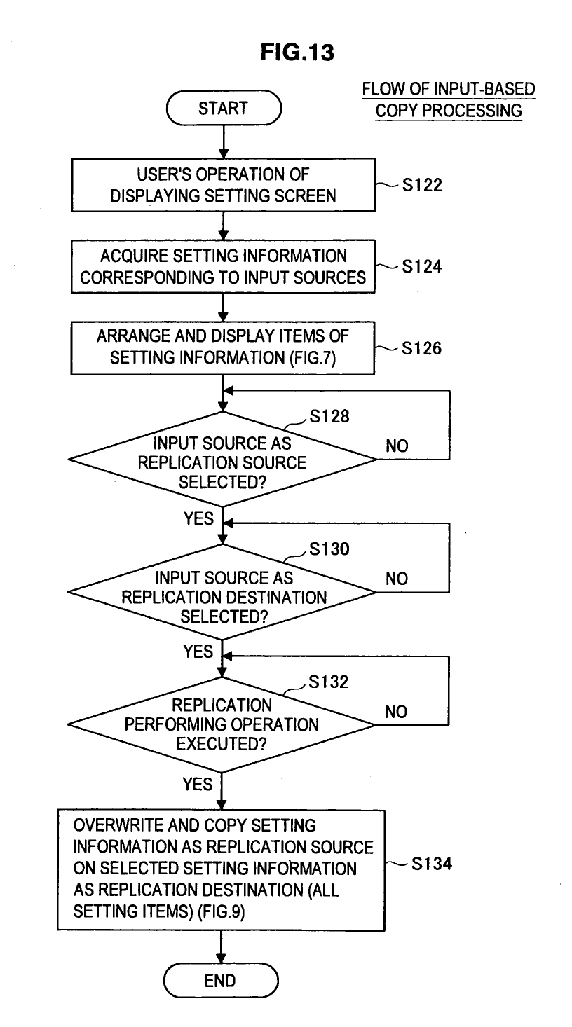

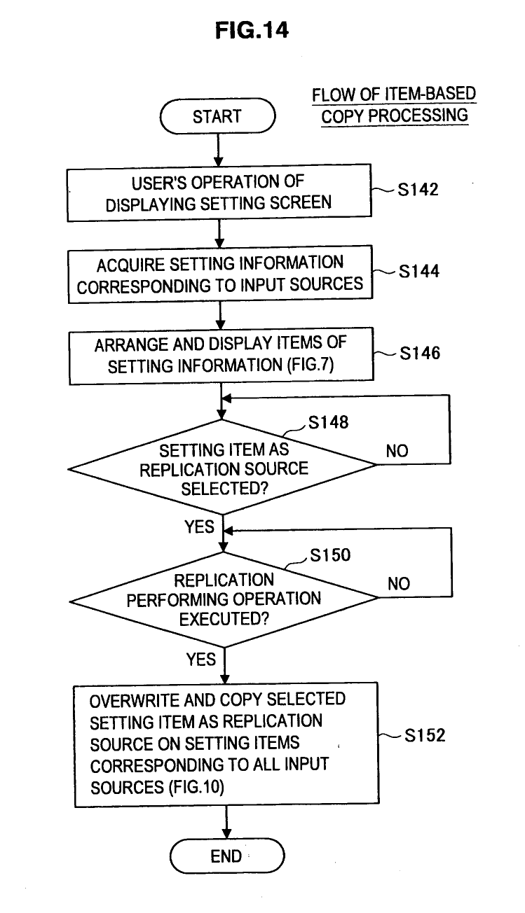

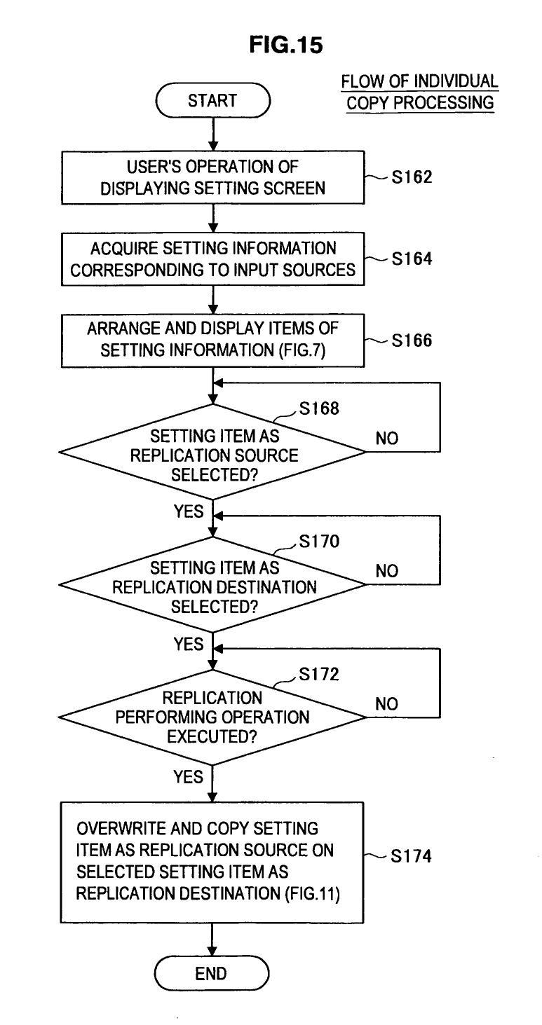

There will be described a flow of the replication processing by the display control unit 210 with reference to FIGS. 12 to 15. FIG. 12 is an explanatory diagram showing a flow of the replication processing performed by the display control unit 210 for the above batch copying. FIG. 13 is an explanatory diagram showing a flow of the replication processing performed by the display control unit 210 for the above input-based copying. FIG. 14 is an explanatory diagram showing a flow of the replication processing performed by the display control unit 210 for the above item-based copying. FIG. 15 is an explanatory diagram showing a flow of the replication processing performed by the display control unit 210 for the individual copying.

When the setting screen is displayed by the user, a list of setting values is displayed in an overview manner. Thereafter, when the user selects the batch copying, the replication processing shown in FIG. 12 is performed. Similarly, when the user selects the input-based copying, the item-based copying or the individual copying, the replication processing as shown in FIG. 13, FIG. 14 or FIG. 15 is performed, respectively. The input source to be subjected to the replication processing, the image quality mode corresponding to each input source, or the like is selected while the list of setting values are being displayed in an overview manner. A series of replication processings as shown in FIGS. 12 to 15 is performed through the selection processings.

### (Flow of Batch Copy Processing)

At first, FIG. 12 will be referred to. As shown in FIG. 12, an operation of displaying the setting screen is first performed by the user via the operation input unit 216 (S102). Next, the display control unit 210 reads out the items of setting information corresponding to a plurality of input sources from the storage unit 212 (S104). Then, the display control unit 210 arranges and displays a plurality of items of setting information on the display unit 122 as shown in FIG. 7 (S106). At this time, the display control unit 210 inquires of the setting information management unit 218 for the kind of the setting information to be display, the arrangement order of the items of setting information and the arrangement order of the setting items, and displays the setting information depending on the response contents acquired from the setting information management unit 218.

Next, the display control unit 210 determines whether the setting information of the input source as replication source has been selected (S108). As described above, the display control unit 210 may be configured to automatically select the setting information displayed at the first column of the setting screen for the replication source region A10. However, there may be configured such that the user can arbitrarily select the replication source region A10 from the items of setting information displayed on the setting screen. When there is configured such that the user can arbitrarily select the replication source region A10, the display control unit 210 waits until the user selects the replication source region A10 as in step S108. When the setting information of the input source as replication source is selected, the display control unit 210 proceeds to a processing in step S110.

In step S110, a determination is made as to whether the operation of instructing to perform the replication processing has been performed by the user (S110). As described above, in the case of the batch copying, since the replication destination region A20 is determined when the replication source region A10 is selected, the display control unit 210 can automatically perform the replication processing. However, since the user is given a change to determine the executability, the display control unit 210 may cause the user to input the executing instruction. In this case, the display control unit 210 waits until the user inputs the executing instruction as in step S110. Then, when the executing instruction is input by the user, the display control unit 210 proceeds to a processing in step S112.

In step S112, the setting information contained in the replication source region A10 is overwritten and copied on the setting information contained in the replication destination region A20 by the display control unit 210 (S112). In the case of the batch copying, the adjustment values of all the setting items contained in the replication source region A10 are copied to all the corresponding setting items contained in the replication destination region A20. When the replication processing is completed in this manner, the display control unit 210 terminates a series of processings for the batch copying.

### (Flow of Input-Based Copy Processing)

Next, FIG. 13 will be referred to. As shown in FIG. 13, the operation of displaying the setting screen is first performed by the user via the operation input unit 216 (S122). Next, the display control unit 210 reads out the items of setting information corresponding to a plurality of input sources from the storage unit 212 (S124). Then, the display control unit 210 arranges and displays a plurality of items of setting information on the display unit 122 as shown in FIG. 7 (S126). At this time, the display control unit 210 inquires of the setting information management unit 218 for the kind of the setting information to be displayed, the arrangement order of the items of setting information and the arrangement order of the setting items, and displays the setting information depending on the response contents acquired from the setting information management unit 218.

Next, the display control unit 210 determines whether the setting information of the input source as replication source has been selected (S128). As described above, the display control unit 210 may be configured to automatically select the setting information displayed at the first column of the setting screen for the replication source region A10. However, there may be configured such that the user can arbitrarily select the replication source region A10 from the items of setting information displayed on the setting screen. When there is configured such that the user can arbitrarily select the replication source region A10, the display control unit 210 waits until the user selects the replication source region A10 as in step S108. When the setting information of the input source as replication source is selected, the display control unit 210 proceeds to a processing in step S130.

In step S130, the display control unit 210 determines whether the setting information of the input source as replication destination has been selected (S130). As described above, in the case of the input-based copying, unlike the batch copying, the replication destination region A22 is not automatically selected. Thus, the user needs the operation of selecting the replication destination region A22. Thus, the display control unit 210 waits until the user selects the replication destination region A22 as in step S130. When the setting information of the input source as replication destination is selected, the display control unit 210 proceeds to a processing in step S132.

In step S132, a determination is made as to whether the user has performed the operation of instructing to perform the replication processing (S132). As described above, there may be configured such that the display control unit 210 automatically performs the replication processing when the replication source region A10 and the replication destination region A22 are selected. However, since the user is given a chance to determine the executability, the display control unit 210 may cause the user to input the executing instruction. In this case, the display control unit 210 waits until the user inputs the executing instruction as in step S132. Then, when the user inputs the executing instruction, the display control unit 210 proceeds to a processing in step S134.

In step S134, the setting information contained in the replication source region A10 is overwritten and copied on the setting information contained in the replication destination region A22 by the display control unit 210 (S134). In the case of the input-based copying, the adjustment values of all the setting items contained in the replication source region A10 are copied to all the corresponding setting items contained in the replication destination region A22. When the replication processing is completed in this manner, the display control unit 210 terminates a series of processings for the input-based copying.

### (Flow of Item-Based Copy Processing)

Next, FIG. 14 will be referred to. As shown in FIG. 14, the operation of displaying the setting screen is first performed by the user via the operation input unit 216 (S142). Next, the display control unit 210 reads out the items of setting information corresponding to a plurality of input sources from the storage unit 212 (S144). Then, the display, control unit 210 arranges and displays a plurality of items of setting information on the display unit 122 as shown in FIG. 7 (S146). At this time, the display control unit 210 inquires of the setting information management unit 218 for the kind of the setting information to be displayed, the arrangement order of the items of setting information and the arrangement order of the setting items, and displays the setting information depending on the response contents acquired from the setting information management unit 218.

Next, the display control unit 210 determines whether the setting item as replication source has been selected (S148). As described above, in the case of the item-based copying, unlike the batch copying and the input-based copying, the replication source region A12 is not automatically selected. Thus, the user needs the operation of selecting the replication source region A12. The display control unit 210 waits until the user selects the replication source region A12 as in step S148. When the setting item as replication source is selected, the display control unit 210 proceeds to a processing in step S150.

In step S150, a determination is made as to whether the user has performed the operation of instructing to perform the replication processing (S150). As described above, in the case of the item-based copying, since the replication destination region A24 is determined when the replication source region A12 is selected, the display control unit 210 can automatically perform the replication processing. Since the user is given a change to determine the executability, the display control unit 210 may cause the user to input the executing instruction. In this case, the display control unit 210 waits until the user inputs the executing instruction as in step S150. Then, when the executing instruction is input by the user, the display control unit 210 proceeds to a processing in step S152.

In step S152, the setting item of the replication source region A12 is overwritten and copied on the setting items of the replication destination region A24 by the display control unit 210 (S152). In the case of the item-based copying, the adjustment value of the setting item designated as the replication source region A12 is copied to all the corresponding setting items contained in the replication destination region A24. When the replication processing is terminated in this manner, the display control unit 210 terminates a series of processings for the item-based copying.

### (Flow of Individual Copy Processing)

Next, FIG. 15 will be referred to. As shown in FIG. 15, the operation of displaying the setting screen is first performed by the user via the operation input unit 216 (S162). Next, the display control unit 210 reads out the items of setting information corresponding to a plurality of input sources from the storage unit 212 (S164). Then, the display control unit 210 arranges and displays a plurality of items of setting information on the display unit 122 as shown in FIG. 7 (S166). At this time, the display control unit 210 inquires of the setting information management unit 218 for the kind of the setting information to be displayed, the arrangement order of the items of setting information and the arrangement order of the setting items, and displays the setting information depending on the response contents acquired from the setting information management unit 218.

Next, the display control unit 210 determines whether the setting item as replication source has been selected (S168). As described above, in the case of the individual copying, unlike the batch copying and the input-based copying, the replication source region A12 is not automatically selected. Thus, the user needs the operation of selecting the replication source region A12. The display control unit 210 waits until the user selects the replication source region A12 as in step S168. When the setting item as replication source is selected, the display control unit 210 proceeds to a processing in step S170.

In step S170, the display control unit 210 determines whether the setting item as replication destination has been selected (S170). As described above, in the case of the individual copying, unlike the batch copying, the replication destination region A26 is not automatically selected. Thus, the user needs the operation of selecting the replication destination region A26. The display control unit 210 waits until the user selects the replication destination region A26 as in step S170. When the setting item as replication destination is selected, the display control unit 210 proceeds to a processing in step S172.

In step S172, a determination is made as to whether the operation of instructing to perform the replication processing has been performed by the user (S172). As described above, there may be configured such that the display control unit 210 automatically performs the replication processing when the replication source region A12 and the replication destination region A26 are selected. However, since the user is given a change to determine the executability, the display control unit 210 may cause the user to input the executing instruction. In this case, the display control unit 210 waits until the user inputs the executing instruction as in step S172. Then, when the executing instruction is input by the user, the display control unit 210 proceeds to a processing in step S174.

In step S174, the setting item designated for the replication source region A12 is overwritten and copied on the setting item as the replication destination region A26 by the display control unit 210 (S174). When the replication processing is terminated in this manner, the display control unit 210 terminates a series of processings for the individual copying.

There has been described above the flow of the replication processing by the display control unit 210. As described above, since the items of setting information are displayed in a list, a number of user's working steps for performing the replication processing become small, thereby largely reducing a user's working load required for the replication processing.

### 7: METHOD FOR FINELY ADJUSTING SETTING INFORMATION

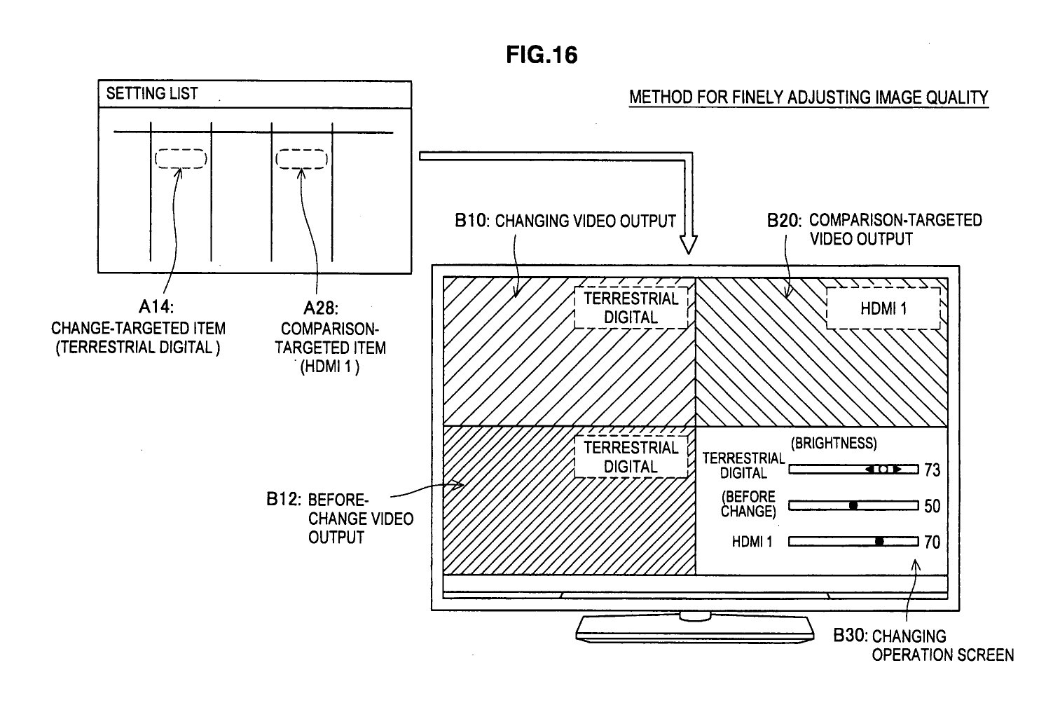

Next, there will be described a method for finely adjusting setting information according to the present embodiment with reference to FIG. 16. FIG. 16 is an explanatory diagram showing the method for finely adjusting setting information according to the present embodiment.

As described above, the user can replicate the setting information by using a desired replicating method. Further, the user can change the adjustment values set for the individual setting items while comparing and referring to the items of setting information displayed in a list. However, in many cases, a difference in video output due to the changing of an adjustment value is not known until it is actually displayed on the display unit 122. In particular, it is necessary for the user him/herself to confirm the influences on the image quality characteristics of the video output by a fine difference between the adjustment values by actually comparing the video outputs. Further, when an adjustment value is set in consideration of the setting information of other input source, the fine adjustment is preferably performed by comparing with the video output of the other input source being selected for comparison. In the present embodiment, there is proposed a technique in which the video output of other input source and the video output to be adjusted are displayed on the same screen and fine adjustment can be made while comparing the video outputs before and after the adjustment.

Specifically, a plurality of videos are displayed on the display unit 122 by the displaying method as shown in FIG. 16. The displaying method described here is realized by the function of the display control unit 210. At first, an adjustment value is set by using the items of setting information displayed in a list by the setting information adjusting method described above. It is assumed for convenient explanation that the terrestrial digital broadcasting is selected as a change-targeted item A14, HDMI1 is selected as a comparison-targeted item A28, and the individual copying is performed from the change-targeted item A14 to the comparison-targeted item A28. The change-targeted item A14 is a setting item to be subjected to the fine adjustment. On the other hand, the comparison-targeted item A28 is a setting item to be compared during the fine adjustment.

The display control unit 210 causes the display unit 122 to display a changing video output B10, an unchanged video output B12, a comparison-targeted video output B20 and a change operation screen B30 as shown in FIG. 16. The changing video output B10 is a video output obtained by reflecting the changing operation by the change operation screen B30 on the video output corresponding to the change-targeted item A14. On the other hand, the unchanged video output B12 is a video output corresponding to the change-targeted item A14, and a video output before the changing operation by the change operation screen B30 is reflected. Further, the comparison-targeted video output B20 is a video output corresponding to the comparison-targeted item A28, and is irrelevant to the changing operation by the change operation screen B30. Then, the change operation screen B30 is a user interface for operation which is used to change the adjustment value of the change-targeted item A14.

An operation object (such as slider) for changing the adjustment value of the change-targeted item A14 is displayed on the change operation screen B30. Further, the adjustment value of the change-targeted item A14 corresponding to the unchanged video output B12 is displayed on the change operation screen B30. Furthermore, the adjustment value of the comparison-targeted item A28 is displayed on the change operation screen B30. The user uses the operation input unit 216 to operate the above operation object displayed on the change operation screen B30, thereby changing the adjustment value of the change-targeted item A14. The adjustment value changed in this manner is reflected on the changing video output B10. In this manner, the adjustment values for the individual video outputs displayed on the display unit 122 are compared with each other so that fine adjustment can be made on the adjustment values while visually confirming the difference in video output. The difference in image quality characteristics due to the difference in input source can be obviously seen.

There have been described above the configuration of the video displaying apparatus 100, the setting information displaying method and the video displaying method according to the present embodiment in detail. As described above, the items of setting information corresponding to a plurality of input sources are displayed in a list, thereby easily recognizing whether the difference in image quality appearing when the input source is switched is due to the difference in image quality adjustment value. Further, the image quality adjustment value can be set while referring to the items of setting information of difference input sources, so that the setting work is made remarkably efficient and a user's working load can be largely reduced. Furthermore, if the replicating method according to the present embodiment is applied, the items of setting information displayed in a list can be efficiently replicated, thereby making the setting work efficient. The fine adjustment is made on the image quality adjustment value while comparing and referring to different video outputs, so that the fine adjustment can be easily made on the image quality adjustment value in consideration of the image quality characteristics for each input source.

### 8: CONCLUSION

Finally, there will be briefly concluded the functional configuration of the video displaying apparatus according to the present embodiment and the operational effects obtained from the functional configuration.

At first, the functional configuration of the video displaying apparatus according to the present embodiment can be expressed as follows. The video displaying apparatus includes a plurality of video input units, a display unit and a display control unit as follows. Mutually different video signals are input into the plurality of video input units. Further, the display unit displays thereon the video signals. The display control unit is directed for displaying the items of setting information on the display setting of the video signals input from the individual video input units on the display unit in a list. As described above, when a video quality is different in switching the video input unit, it is difficult to determine whether the cause therefor is due to the setting information. However, the items of setting information corresponding to a plurality of video input units are displayed in a list by the display control unit so that the difference between the items of setting information is obviously seen, thereby easily finding the setting information to be adjusted. The items of setting information for a plurality of video input units can be referred to without changing the setting screen, thereby performing the adjustment working while mutually comparing the items of setting information. Consequently, the user's working load is reduced, thereby improving user's convenience.

The setting information may be provided with a plurality of setting items. In this case, the video displaying apparatus further includes an arrangement order table storage unit in which the arrangement order of the setting items is recorded correspondingly to the individual video input unit or a predetermined display mode. When one item of setting information displayed in a list on the display unit is selected or when a predetermined display mode is selected, the display control unit rearranges the plurality of setting items based on the arrangement order recorded in the arrangement order table storage unit. As described above, if the video input unit or display mode is different, the kind of the adjustment value largely influencing the image quality is different. Further, if the largely-influencing adjustment value is displayed at an inconspicuous position, it takes much time for the user to find the adjustment value. However, with the above configuration, the setting items to be set are arranged and displayed for each video input unit or display mode, the user makes the adjustment on the setting items arranged at the higher position, thereby efficiently and effectively setting the adjustment value.

The video displaying apparatus can further include a difference setting detection unit for, when the setting information as a reference is determined, detecting an item of setting information having a large difference relative to the reference setting information. In this case, the display control unit arranges the setting information detected by the difference setting detection unit along with the reference setting information and displays the same in a list on the display unit. As described above, the setting information having a large difference is the setting information to be preferentially set in many cases. Further, when the user performs the setting work while comparing and referring to the setting information, the user can more easily refer to the adjustment values when the reference setting information and the setting information to be set are closely arranged and displayed. Thus, with the above configuration, the reference setting information and the setting information to be set are closely arranged and displayed so that the setting work is made efficient when the user sets the adjustment value. Furthermore, the adjustment value is less likely misunderstood when being referred to, thereby reducing a setting error of the adjustment value.

The difference setting detection unit may be configured to, when one item of setting information displayed in a list on the display unit is selected by the user, detect the setting information having a large difference with the selected setting information as the reference setting information. In this manner, the user can arbitrarily set the reference setting information, so that the setting information to be set can be detected while sequentially changing the reference setting information.

The difference setting detection unit may be configured to, when a predetermined display mode is selected, detect the setting information having a large difference with the setting information corresponding to the display mode as the reference setting information. With the above configuration, the setting information to be set at the same setting information as the display mode is automatically detected with reference to the setting information suitable for the predetermined display mode, and thereby the user does not need to search for the setting information to be set. For example, when a video input from a certain video input unit is viewed in a predetermined display mode, it can easily confirm whether the setting information of the video input unit is largely different from the setting information suitable for the predetermined display mode. Further, if the setting information is largely different, the user can adjust the setting information while referring to the adjustment value of the setting information suitable for the predetermined display mode.

The video displaying apparatus can further include a setting information replication unit for overwriting one item of setting information selected from the items of setting information displayed in a list on the display unit on the other item of setting information. In this case, the setting information replication unit overwrites, when one item of setting information as replication source and the other item of setting information as replication destination are selected, the information on all the setting items contained in the one item of setting information on the setting items contained in the other item of setting information. With the above configuration, the contents of the setting information close to a desired adjustment value can be replicated without inputting the adjustment values in the individual items of setting information. The setting information close to a desired adjustment value is replicated and then fine adjustment is made on only part of the setting items, thereby remarkably reducing a user's working load.

The video displaying apparatus may further include a setting information replication unit for overwriting one item of setting information selected from the items of setting information displayed in a list on the display unit on the other item of setting information. In this case, the setting information replication unit overwrites, when the one item of setting information as replication source and the other item of setting information as replication destination are selected and further part of the setting items contained in the one item of setting information is selected, the information on the selected setting items from the setting items contained in the one item of setting information on the setting items contained in the other item of setting information. In this manner, replication can be performed for each setting item so that only the setting items largely influencing the image quality in a certain display mode or the like can be collectively adjusted, for example.

Furthermore, the display control unit may be configured to, when the items of setting information corresponding to the two video input units are selected, display in a list a setting change screen for changing one item of setting information, a changed video screen for displaying thereon a video signal based on the setting information changed in the setting change screen, an unchanged video screen for displaying thereon the video signal before the setting change, and a comparison video screen for displaying thereon a video signal based on the setting information different from the one item of setting information for comparison. In this manner, when the setting information is finely adjusted, a video output of other video input unit can be compared in addition to the video output before and after the fine adjustment. As a result, the video information can be finely adjusted in consideration of the image quality characteristics of the video input unit, the image quality characteristics of the video signal and the like. Further, the image quality characteristics of the video output actually changing by the fine adjustment can be confirmed in real time, thereby improving the working efficiency at the time of fine adjustment.

### (Remarks)

The video reception units 202, 204, the external device connection unit 206 and the network reception unit 208 described above are merely examples of the video input unit. The above display control unit 210 is one example of the setting information replication unit.

It should be understood by those skilled in the art that various modifications, combinations, sub-combinations and alterations may occur depending on design requirements and other factors insofar as they are within the scope of the appended claims or the equivalents thereof.

For example, in the explanation of the aforementioned embodiment, it was assumed that the number of items of setting information to be displayed in a list on the display unit 122 is limited for convenient explanation. However, the technique according to the above embodiment can be performed in the user interface in which the contents displayed on the display unit 122 are laterally scrolled. In this case, the scrolling increases the number of items of setting information to be displayed on the display unit 122, but the number of items to be displayed in a list at one time is limited. Thus, also in this case, the technique according to the above embodiment is applied so that the effect of remarkably improving user's convenience can be obtained.

There has been described in the explanation of the above embodiment the technique in which the items of setting information are ordered by the difference setting detection unit 220 and the columns of the items of setting information are sorted by the setting information management unit 218 according to the order. The sort processing is directed for increasing the effects obtained by the application of the present embodiment, and for example there may be configured such that the items of setting information are arranged in a default-set arrangement order. In this case, the arrangement order of the items of setting information can be manually changed by the user, for example. In this manner, the configuration of changing the arrangement orders of the items of setting information and the setting items can be variously changed.

The present application contains subject matter related to that disclosed in Japanese Priority Patent Application JP 2008-285231 filed in the Japan Patent Office on Nov. 6, 2008, the entire content of which is hereby incorporated by reference.

What is claimed is:

1. A video displaying apparatus comprising:
a plurality of video input unit configured to input mutually different video signals;
a display unit configured to display the video signals thereon; and
a display control unit configured to display setting information on a display setting of a video signal input from the individual video input unit on the display unit in a list.

2. The video displaying apparatus according to claim 1, wherein the setting information is provided with a plurality of setting items;
the video displaying apparatus further includes an arrangement order table storage unit configured to record therein an arrangement order of the setting items in correspondence to the individual video input unit or a predetermined display mode, and
the display control unit, when one item of setting information displayed in a list on the display unit is selected or when a predetermined display mode is selected, rearranges the plurality of setting items based on the arrangement order recorded in the arrangement order table storage unit.

3. The video displaying apparatus according to claim 1, further comprising a difference setting detection unit, when the setting information as a reference is determined, configured to detect setting information having a large difference relative to the reference setting information,
wherein the display control unit arranges setting information detected by the difference setting detection unit together with the reference setting information and displays them in a list on the display unit.

4. The video displaying apparatus according to claim 3, wherein the difference setting detection unit, when a user selects one item of setting information displayed in a list on the display unit, detects the setting information having a large difference with the selected setting information as the reference setting information.

5. The video displaying apparatus according to claim 3, wherein the difference setting detection unit, when a predetermined display mode is selected, detects the setting information having a large difference with the setting information corresponding to the display mode as the reference setting information.

6. The video displaying apparatus according to claim 2, further comprising a setting information replication unit configured to overwrite one item of setting information selected from the items of setting information displayed in a list on the display unit on the other item of setting information,
wherein the setting information replication unit, when the one item of setting information as replication source and the other item of setting information as replication destination are selected, overwrites the information on all the setting items contained in the one item of setting information on the setting items contained in the other item of setting information.

7. The video displaying apparatus according to claim 2, further comprising a setting information replication unit configured to overwrite one item of setting information selected from the items of setting information displayed in a list on the display unit on the other item of setting information,
wherein the setting information replication unit, when the one item of setting information as replication source and the other item of setting information as replication destination are selected and part of the setting items contained in the one item of setting information is selected, overwrites the information on the selected setting item among the setting items contained in the one item of setting information on the setting items contained in the other item of setting information.

8. The video displaying apparatus according to claim 1, wherein the display control unit, when setting information corresponding to the two video input units is selected, displays a setting change screen for changing one item of setting information, a changed video screen for displaying thereon a video signal based on setting information changed in the setting change screen, an unchanged video screen for displaying thereon the video signal before setting change, and a comparison video screen for displaying thereon a video signal based on the setting information different from the one item of setting information for comparison in a list on the display unit.

9. A method for displaying setting information, including the steps of:
inputting videos into a plurality of video input units to which mutually different video signals are input; and
displaying setting information on a display setting of a video signal input from the individual video input unit in a list on a display screen.

10. A video displaying apparatus comprising:
a plurality of video input means for inputting mutually different video signals;
display means for displaying the video signals thereon; and
display control means for displaying setting information on a display setting of a video signal input from the individual video input means on the display means in a list.
